(19) United States
(12) Patent Application Publication
(10) Pub. No.: US 2018/0046324 A1
(43) Pub. Date: Feb. 15, 2018

(54) PROJECTION SYSTEM AND TOUCH SENSING DEVICE

(71) Applicant: Coretronic Corporation

(72) Inventors: Hao-Feng Hung, Hsin-Chu (TW); Yung-Chih Chen, Hsin-Chu (TW)

(73) Assignee: Coretronic Corporation, Hsin-Chu (TW)

(21) Appl. No.: 15/673,416

(22) Filed: Aug. 10, 2017

(30) Foreign Application Priority Data
Aug. 11, 2016 (CN) 201610654656.4

(51) Int. Cl. G06F 3/041; G06F 3/0354; H04N 9/31; G06F 3/042

(52) U.S. Cl. CPC G06F 3/0418; G06F 3/0421; G06F 3/0425; G06F 3/03542; H04N 9/3188; H04N 9/3194; H04N 9/3161; G06F 2203/04106

(57) ABSTRACT

A projection system including a projection display device and a touch sensing device is provided. The projection display device is configured to project an image frame to a projection plane. The projection display device includes a first signal transmission interface. The touch sensing device is electrically connected to the projection display device. The touch sensing device is configured to sense a touch operation on the projection plane. The touch sensing device includes a second signal transmission interface. The projection display device and the touch sensing device perform a signal transfer operation via the first signal transmission interface and the second signal transmission interface. The signal transfer operation includes transferring an image parameter of the image frame.

### CROSS-REFERENCE TO RELATED APPLICATION

This application claims the priority benefit of China application serial no. 201610654656.4, filed on Aug. 11, 2016. The entirety of the above-mentioned patent application is hereby incorporated by reference herein and made a part of this specification.

### BACKGROUND

### 1. Field of the Invention

The invention relates to an optical system and an optical device, and more particularly, to a projection system and a touch sensing device.

### 2. Description of Related Art

In projection systems with a touch sensing function of the conventional technology, a projection display device and a touch sensing device are unable to exchange information with each other due to the absence of signal transmission interfaces connected between the two devices. When the user uses a different host system or when a parameter of an image frame provided by the host system is changed, because the touch sensing device is unable to obtain information regarding the parameter of the image frame already being changed, a calibration procedure is required to perform a secondary calibration in order to use the touch sensing function correctly. In addition, when the user uses a different laser source to perform the touch sensing function, a corresponding touch sensing operation cannot be performed correctly if the touch sensing device is unable to learn that a touch mode is already changed. Various operational issues caused by the absence of the signal transmission interfaces connected between the projection display device and the touch sensing device may incur inconvenience during operation for the user thereby causing poor user experience.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The invention provides a projection system with the touch sensing function, which is capable of providing favorable user experience.

The invention provides a touch sensing device with a touch sensing function, which is adapted to a projection system and also capable of providing favorable user experience.

Other objects and advantages of the invention can be further illustrated by the technical features broadly embodied and described as follows.

To achieve one, a part, or all of the objects or other objects, an embodiment of the invention proposes a projection system, which includes a projection display device and a touch sensing device. The projection display device is configured to project an image frame on a projection plane. The projection display device includes a first signal transmission interface. The touch sensing device is electrically connected to the projection display device. The touch sensing device is configured to sense a touch operation on the projection plane. The touch sensing device includes a second signal transmission interface. The projection display device and the touch sensing device perform a signal transfer operation via the first signal transmission interface and the second signal transmission interface. The signal transfer operation includes transferring an image parameter of the image frame.

An embodiment of the invention proposes a touch sensing device, which is adapted to a projection system. The touch sensing device includes a signal transmission interface and another signal transmission interface. The signal transmission interface is configured to electrical connect to a projection display device.

The projection display device projects an image frame on a projection plane. The touch sensing device is configured to sense a touch operation on the projection plane. The projection display device and the touch sensing device perform a signal transfer operation via the transmission interface, and the signal transfer operation includes transferring an image parameter of the image frame. The another signal transmission interface of the touch sensing device is configured to electrically connect to a host system. The touch sensing device provides a sensing result corresponding to the touch operation to the host system.

Based on the above, the embodiments of the invention have at least one the following advantages and effects. According to the embodiments of the invention, the projection display device and the touch sensing device can perform the signal transfer operation via the first signal transmission interface and the second signal transmission interface, such that favorable user experience may be provided.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 illustrates a schematic diagram of a projection system according to an embodiment of the invention.

FIG. 2 illustrates a block diagram of internal parts of the projection display device and the projection display device in FIG. 1.

FIG. 3 illustrates a flowchart of steps in an operating method of the touch sensing device according to an embodiment of the invention.

FIG. 4 illustrates a flowchart of steps in an operating method of the touch sensing device according to another embodiment of the invention.

### DESCRIPTION OF THE EMBODIMENTS

It is to be understood that both the foregoing and other detailed descriptions, features and advantages are intended to be described more comprehensively by providing preferred embodiments accompanied with figures hereinafter. The language used to describe the directions such as up, down, left, right, front, back or the like in the reference drawings is regarded in an illustrative rather than in a restrictive sense. Thus, the language used to describe the directions is not intended to limit the scope of the invention.

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

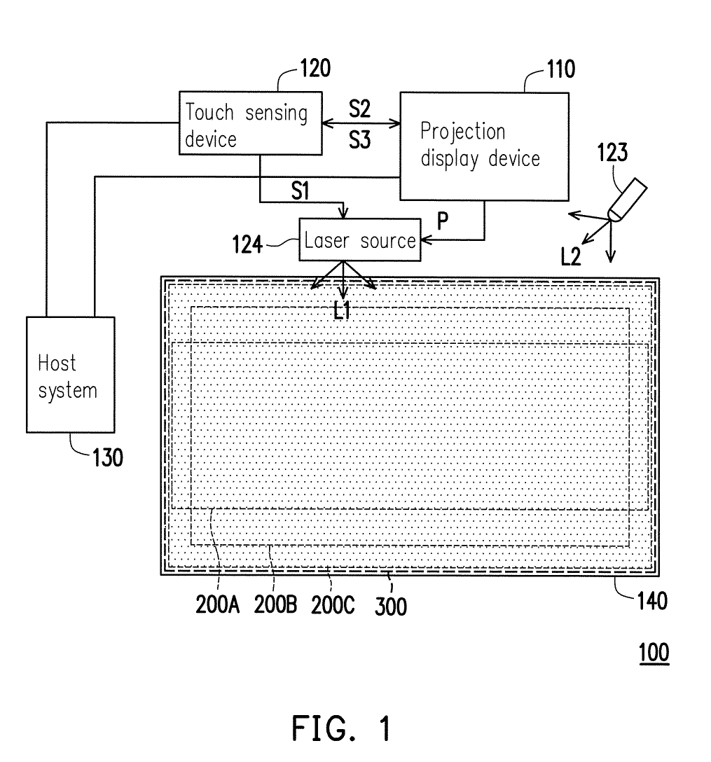

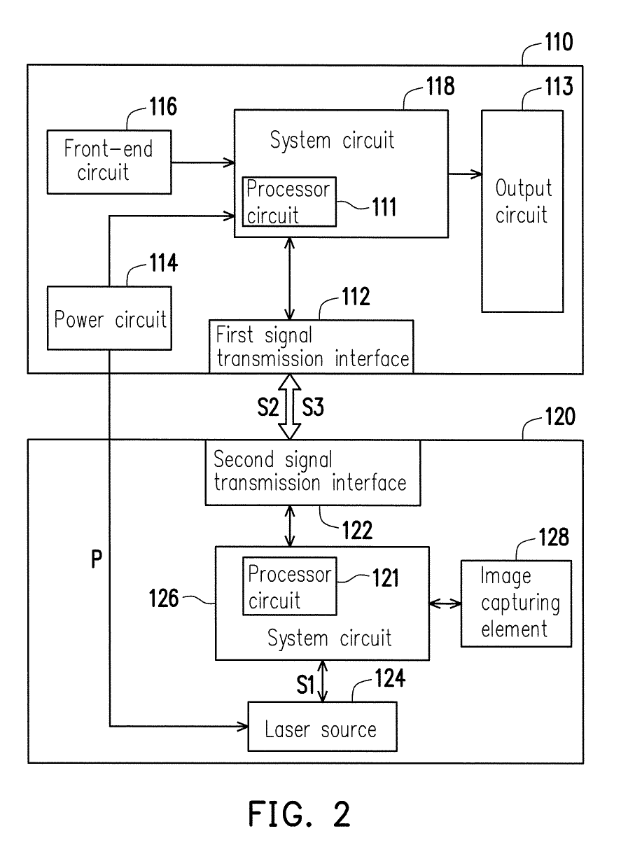

FIG. 1 illustrates a schematic diagram of a projection system according to an embodiment of the invention. FIG. 2 illustrates a block diagram of internal parts of the projection display device and the projection display device in FIG. 1. Referring to FIG. 1 and FIG. 2, a projection system 100 of the embodiment has a touch sensing function and includes at least two different touch modes. In the embodiment, the projection system 100 includes a projection display device 110, a touch sensing device 120, a host system 130 and a projection plane 140 such as a screen, a wall or PCT (projected capacitive touch) film and the like. In the embodiment, the projection system 100 further includes a laser source 124 and a laser pen 123. The touch sensing device 120 is electrically connected to the projection display device 110. The host system 130 is electrically connected to the projection display device 110 and the touch sensing device 120. The projection display device 110 may be a projector or a display (e.g., a LCD display) capable of displaying an image frame. The projection display device 110 is a display, the projection plane 140 can be defined as the above surface of the display the observer may see the image frame, but the invention is not limited thereto.

Specifically, in the embodiment, the host system 130 is configured to provide an image frame (200A, 200B or 200C) to the projection display device 110. For instance, the host system 130 provides the image frame (200A, 200B or 200C) to the projection display device 110 via an image transmission interface, for example. The image transmission interface includes, for example, a Video Graphics Array (VGA) interface, a High Definition Multimedia Interface (HDMI) interface, a separate video (S-video) terminal interface or other similar interfaces. In the embodiment, the host system 130 is configured to control the projection display device 110 to project an image corresponding to a touch operation on the projection plane 140. The host system 130 is configured to set an image parameter of the image frame (200A, 200B or 200C).

In the embodiment, the host system 130 is selected from one of a portable device, a non-portable device and a wearable device, for example. The non-portable device includes a desktop computer, a cloud service system, a car display system or other similar devices. The portable device includes a notebook computer, a tablet computer, a smart phone or other similar devices. The wearable device includes a smart witch, a headset display or other similar devices. Type of the host system 130 is not particularly limited by the invention.

In the embodiment, the projection display device 110 is configured to project the image frame (200A, 200B or 200C) on the projection plane 140. For instance, the projection display device 110 projects the image frame (200A, 200B or 200C) on the projection plane 140 according to the image parameter. The image parameter includes, for example, an image resolution, an image brightness, an image spectrum distribution, an image resolution, an image diversity, an image correlation, an image color number, an image update rate or a display mode or other similar parameters. In the embodiment, the image parameter includes, for example, at least one of a size dimension and a resolution of the image frame (200A, 200B or 200C). The image frame (200A, 200B or 200C) projected by the projection display device 110 may include a different frame size and a different aspect ratio based on a different resolution setting included by the image from the image source provided by the host system 130. Each of the image frames 200A, 200B and 200C in FIG. 1 represents a projected frame of a different projection resolutions, for example.

In the embodiment, the touch sensing device 120 is configured to sense the touch operation on the projection plane 140 and transfer a sensing result to the host system 130. The sensing result includes, for example, a touch position obtained through calculation. For example, the projection plane 140 may be a PCT (projected capacitive touch) film. The PCT film comprises a reflective layer, a touch sensing layer and a substrate. The reflective layer may be reflected the image light of the image frame. The touch sensing layer receives the touch operation to generate a sensing result transferring to the host system 130.

In the embodiment, the touch sensing device 120 defines a sensing range according to the image parameter of the image frame (200A, 200B or 200C) received by the projection display device 110 so the touch sensing device 120 is able to sense the touch operation on the projection plane 140 within the sensing range. Specifically, the touch sensing device 120 receives an image parameter S2. In the embodiment, the sensing range may be correspondingly adjusted according to the size dimension of the image frame (200A, 200B or 200C) to be, for example, greater than, less than or equal to the size dimension of the image frame (200A, 200B or 200C) or in proportion to the size dimension of the image frame (200A, 200B or 200C). In the embodiment, the size dimension of the image frame (200A, 200B or 200C) is, for example, the aspect ratio of the image frame (e.g., 4:3 or 16:9). For instance, the touch sensing device 120 can provide the sensing result corresponding to the touch operation to the host system 130. In other words, the touch sensing device 120 can reflect the corresponding touch operation onto desktop or application software of the host system 130 and display the touch operation on the image frame (200A, 200B or 200C) through the projection display device 110. The projection display device 110 receives the content and the resolution setting of the image provided by the host system 130 and projects image frame (200A, 200B or 200C) on the projection plane 140. In the touch sensing device 120, at least one sensing device (e.g., an image capturing element 128 of FIG. 2) is responsible for sensing the touch position of a finger of the user or a sensing apparatus (e.g., a stylus) on the image frame (200A, 200B or 200C) and a calculation of an image algorithm is performed on the sensed image by a processor circuit 121 or a hardware calculating element in the touch sensing device 120. In the embodiment, the touch position is the sensing result to be transferred to the host system 130, which is generated by the processor circuit 121 of the touch sensing device 120 which automatically analyzes and compares a coordinate of the sensed image and an image coordinate of a predetermined image to be projected from the projection display device 110 with use of a coordinate conversion method. The hardware calculating element includes, for example, a digital signal processor (DSP), a field programmable gate array (FPGA), a complex programmable logic device (CPLD) or other similar elements. Next, the touch sensing device 120 returns a touch coordinate position in a standard format (e.g., Human Interface Devices; HID) back to the host system 130 via the signal transmission interfaces (e.g., a Universal Serial Bus (USB)).

In the embodiment, the projection system 100 has the touch sensing function and includes at least two different touch modes, such as a first touch mode and a second touch mode.

In the first touch mode, the projection display device 110 is configured to provide an operating power P to the laser source 124. The laser source 124 is configured to provide a laser curtain 300. The laser curtain 300 is adjacent to a lateral side of the projection plane 140 receiving the image frame. For example, the laser curtain 300 is in parallel to the projection plane 140 and spaced by a distance from the projection plane 140, but the invention is not limited thereto. A touch object (e.g., the finger of the user or the touch apparatus) performs the touch operation on the lateral side of the projection plane 140. The touch object reflects a first laser L1 projected by the laser source 124. In the first touch mode, the touch sensing device 120 determines the touch position of the touch operation on the projection plane 140 according to the reflected first laser L1. Specifically, the first laser L1 is outputted from the laser source 124 to form the laser curtain 300. When the finger of the user touches the laser curtain 300, the first laser L1 is reflected by the finger of the user. The reflected first laser L1 is received the image capturing element 128 of the touch sensing device 120 and used to calculate the touch position. The laser source 124 is operated by controlling an on/off time and period by using, for example, a control signal S1 outputted by the touch sensing device 120.

In the second touch mode, the laser pen 123 is configured to output a second laser L2 for performing the touch operation on the projection plane 140. In the second touch operation, the touch sensing device 120 determines the touch position of the touch operation on the projection plane 140 according to the second laser L2.

Referring to FIG. 2, in the embodiment, the projection display device 110 includes a first signal transmission interface 112. The touch sensing device 120 includes a second signal transmission interface 122. In the embodiment, each of the projection display device 110 and the touch sensing device 120 performs a signal transfer operation between the projection display device 110 and the touch sensing device 120 via the first signal transmission interface 112 and the second signal transmission interface 122 (Two-Way Communication), or the projection display device 110 and the touch sensing device 120 perform the signal transfer operation via the first signal transmission interface 112 and the second signal transmission interface 122 (One-Way Communication). For instance, the projection display device 110 outputs the image parameter related to the image frame (200A, 200B or 200C) via the first signal transmission interface 112 to be transferred to the transmission interface 120. The touch sensing device 120 receives the image parameter outputted by the projection display device 110 via the second signal transmission interface 122.

In the embodiment, the first signal transmission interface 112 and the second signal transmission interface 122 are, for example, in compliance with the following transmission interface standards: a UART bus (Universal Asynchronous Receiver/Transmitter bus), a I2C BUS (Inter-Integrated Circuit bus), a SPI bus (Serial Peripheral Interface bus) or other similar signal transmission interfaces, but the invention is not limited to the above. Types of the first signal transmission interface 112 and the second signal transmission interface 122 are not particularly limited by the invention.

In the embodiment, when the projection display device 110 is set to stop providing the operating power P to the laser source 124, the projection display device 110 transfers a mode-switching signal S3 to the transmission interface 120 via the first signal transmission interface 112 and the second signal transmission interface 122. Next, the touch sensing device 120 is switched from the first touch mode to the second touch mode according to the mode-switching signal S3.

In the embodiment, the user transfers a projection content to the host system 130 and properly adjusts the resolution so the content may be projected as the image frame (200A, 200B or 200C) by the projection display device 110. When the user intends to use the touch sensing device 120 to perform the touch operation, a calibration procedure is required to accomplish a correct touch sensing. In the embodiment, the signal transfer operation is performed by establishing a communication mechanism between the projection display device 110 and the touch sensing device 120 (i.e., by using the first signal transmission interface 112 and the second signal transmission interface 122). Accordingly, the image parameter regarding the resolution changed by the projection display device 110 may be obtained by the touch sensing device 120. Since the processor circuit 121 in the touch sensing device 120 can calculate and convert the coordinate position for the changed resolution, the user may directly use the touch sensing function without using the calibration procedure to perform the secondary calibration, such that favorable user experience may be provided. In addition, when a power circuit 114 of the projection display device 110 detects that the user switches the touch mode through a control interface (e.g., a remote controller or an OSD interface capable of controlling the projection display device 110), that is, when the laser source 124 is no longer used as a touch light source (i.e., when the projection display device 110 is set to stop providing the operating power P to the laser source 124), the touch sensing device 120 can obtain information regarding a change in light source status via the first signal transmission interface 112 and the second signal transmission interface 122. Accordingly, the touch mode may be switched so a more preferable touch sensing effect may be obtained from touch sensing by the laser pen 123 in the second touch mode to thereby provide favorable user experience.

In the embodiment, when the touch mode is switched from the first touch mode to the second touch mode, energy of the reflected laser L1 is small since what collected by the image capturing element 128 of the touch sensing device 120 in the first touch mode is the first laser L1 reflected by the finger or the touch apparatus. Therefore, the brightness of a light spot shown at the touch position in the frame collected by the image capturing element 128 is low. On the other hand, in the second touch mode, the brightness of a light spot shown by the second laser L2 emitted by the laser pen 123 is high. Based on a result from capturing the frame, while being switched between the first touch mode and the second touch mode, the touch sensing device 120 can adjust a threshold of the brightness of the collected image to obtain a more preferred touch effect since the sensed value may become more sensitive with respect to the different touch modes so favorable user experience may be provided.

Referring continually to FIG. 2, in the embodiment, the projection display device 110 further includes the power circuit 114, a front-end circuit 116, a system circuit 118, a processor circuit 111 and an output circuit 113. The touch sensing device 120 further includes a system circuit 126, the image capturing element 128 and the processor circuit 121.

In the embodiment, the front-end circuit 116 converts an analog video signal into a digital video signal. After converting the resolution of the image, the system circuit 118 then transmits the image frame to the output circuit 113. The output circuit 113 is connected to an optical engine element (not illustrated) and is configured to project the image frame on the projection plane 140. The system circuit 118 obtains the resolution of an inputted frame according to a video signal outputted by the front-end circuit 116 or a video signal of the HDMI interface. According to the resolution, the system circuit 118 adjusts the frame by zooming in or zooming out the frame to fit an output frame.

In the embodiment, the touch sensing device 120 mainly includes the system circuit 126 and further includes the image capturing element 128. An image sensing element of the image capturing element 128 collects image data. The image capturing element 128 is, for example, a camera. The processor circuit 121 can perform an image processing related calculation. The laser source 124 can project the laser curtain 300 on the projection plane 140. When the finger (or the touch apparatus) touches the touch plane 140, the first laser L1 is reflected to show the light spot at the touch position. The system circuit 118 of the projection display device 110 and the system circuit 126 of the touch sensing device 120 include a function of transferring signals by using a Peripheral BUS. The Peripheral BUS includes a UART bus (Universal Asynchronous Receiver/Transmitter bus), an I2C BUS (Inter-Integrated Circuit bus), a SPI bus (Serial Peripheral Interface bus) or other similar signal transmission interfaces. With use of the Peripheral BUS, the touch sensing device 120 can obtain information regarding the inputted resolution from the system circuit 118 of the projection display device 110.

In the embodiment, when finding a value of the inputted resolution being different from that in the previous setting, the touch sensing device 120 automatically calculates the coordinate for conversion and then automatically converts the calculated coordinate into the coordinate position of the changed resolution. Therefore, the user can still use the touch sensing function normally. In addition, when the power circuit 114 of the projection display device 110 detects that the user no longer uses the laser source 124 as the touch sensing source, the projection display device 110 can provide such status to the touch light source 120. As such, the touch sensing device 120 can adjust the related parameter for calculating the image to fit a touch light spot of the laser pen 123 in order to accomplish a favorable touch sensing effect.

In the embodiment, a coordinate conversion method, a coordinate position calculation method and an image processing method may be implemented by steps in any one of the coordinate conversion method, the coordinate position calculation method and the image processing method, which are not particularly limited by the invention. Enough teaching, suggestion, and implementation illustration for aforesaid steps and embodiments thereof may be obtained with reference to common knowledge in the related art, which is not repeated hereinafter.

In the embodiment the image capturing element 128 includes, for example, a charge coupled device image sensor (CCD image sensor) or a complementary metal oxide semiconductor (CMOS) image sensor or other similar devices. Type of the image capturing element 128 is not particularly limited by the invention.

In the embodiment, the processor circuit 111 and the processor circuit 121 includes, for example, Central Processing Unit (CPU), Microprocessor, Digital Signal Processor (DSP), Programmable Logic Device (PLD), or other similar devices, or a combination of the said devices. Types of the processor circuit 111 and the processor circuit 121 are not particularly limited by the invention.

In the embodiment, the power circuit 114, the front-end circuit 116, the system circuit 118, the system circuit 126 and the output circuit 113 may be implemented by respectively using any one of the power circuit, the front-end circuit, the system circuit, the system circuit and the output circuit in the field, which are not particularly limited by the invention. Enough teaching, suggestion, and implementation illustration for aforesaid structure and embodiments thereof may be obtained with reference to common knowledge in the related art, which is not repeated hereinafter.

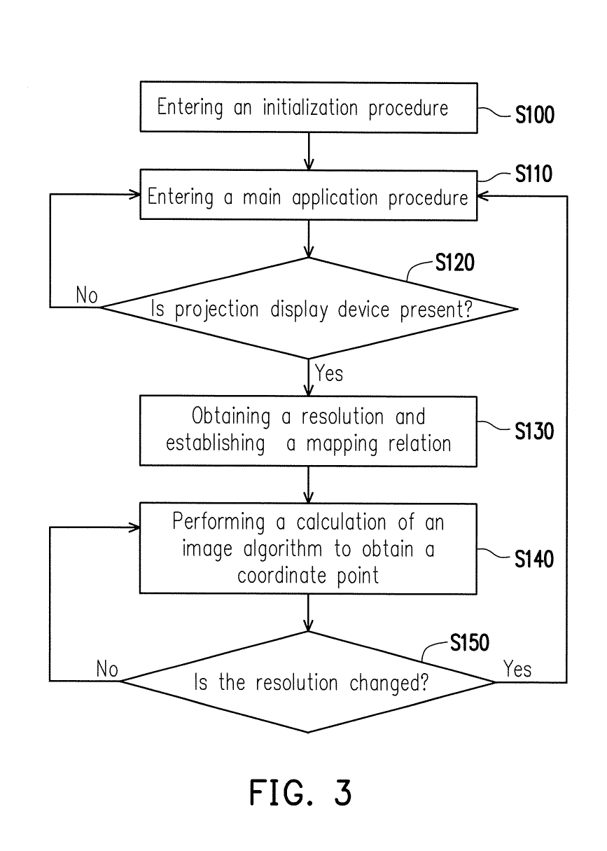

FIG. 3 illustrates a flowchart of steps in an operating method of the touch sensing device according to an embodiment of the invention. Referring to FIG. 1 to FIG. 3, the operating method of the embodiment is at least suitable for the touch sensing device 120 of FIG. 1 and FIG. 2, but the invention is not limited thereto. Taking the touch sensing device 120 of FIG. 2 for example, in the embodiment, in step S100, the touch sensing device 120 enters an initialization procedure after being turned on and the system circuit 126 initializes a peripheral elements (e.g., the image capturing element 128). Next, in step S110, the touch sensing device 120 enters a main application procedure to output or receive commands via the second signal transmission interface 122 so as to determine whether the projection display device 110 is present in step S120. If the projection display device 110 is present, the touch sensing device 120 further obtains an information command so as to obtain a resolution of the projection display device 110 in step S130. Meanwhile, in step S130, the processor circuit 121 calculates and converts the coordinate position for the resolution by, for example, establishing a mapping relation between the resolution and the coordinate position. The mapping relation may be in form of a corresponding coordinate relation or a look-up table, which are not particularly limited by the invention. If the projection display device 110 is not present, the touch sensing device 120 goes back to step S110 so step S110 may be performed again.

Next, in step S140, the processor circuit 121 performs a calculation of an image algorithm to obtain a coordinate point. In step S150, the projection display device 110 determines whether the resolution of the projection display device 110 is changed. If the resolution of the projection display device 110 is not changed, the processor circuit 121 goes back to step S140 and calculates the coordinate position according to the mapping relation established in step S130. If the resolution of the projection display device 110 is changed, the touch sensing device 120 goes back to step S110 so steps S110, S120 and S130 may be performed again to establish a new mapping relation between the new resolution and the coordinate position according to the information regarding the resolutions before and after the change in step S130. Then, the coordinate position may be calculated from coordinate values by the processor circuit 121 according to the mapping relation after the change.

In addition, sufficient teaching, suggestion, and implementation illustration regarding the operating method of the touch sensing device in the embodiments of the invention may be obtained from the above embodiments depicted in FIG. 1 and FIG. 2, and thus related description thereof is not repeated hereinafter.

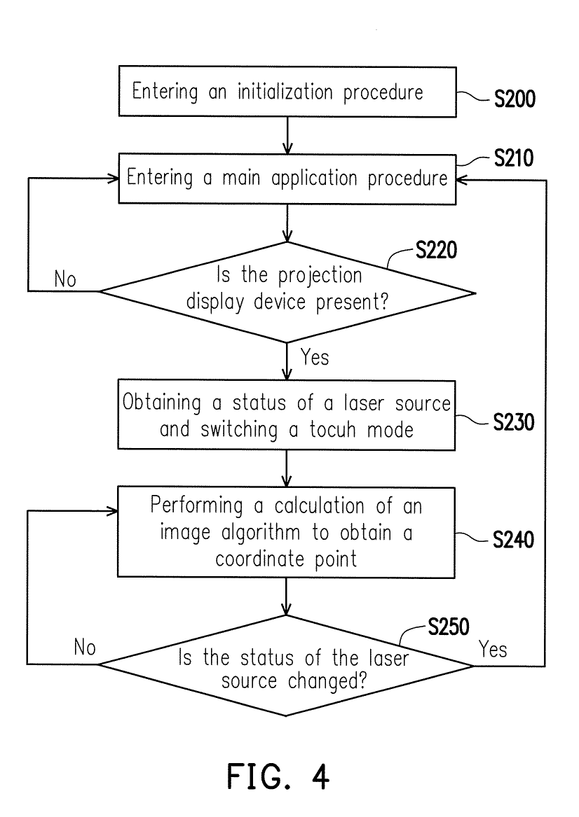

FIG. 4 illustrates a flowchart of steps in an operating method of the touch sensing device according to another embodiment of the invention. Referring to FIG. 1, FIG. 2 and FIG. 4, the operating method of the embodiment is at least suitable for the touch sensing device 120 of FIG. 1 and FIG. 2, but the invention is not limited thereto. Taking the touch sensing device 120 of FIG. 2 for example, in the embodiment, in step S200, the touch sensing device 120 enters an initialization procedure after being turned on and the system circuit 126 initializes a peripheral element (e.g., the image capturing element 128). Next, in step S210, the touch sensing device 120 enters a main application procedure to output or receive commands via the second signal transmission interface 122 so as to determine whether the projection display device 110 is present in step S220. If the projection display device 110 is present, the touch sensing device 120 further obtains an information command so as to obtain a status of the laser source 124 in step S230. Meanwhile, in step S230, the processor circuit 121 switches a touch mode of the touch sensing device 120 according to the status of the laser source 124. For example, if the power of the laser source 124 is turned off, the processor circuit 121 selects to switch the touch sensing device 120 to a second touch mode. If the power of the laser source 124 is not turned off, the processor circuit 121 selects to switch the touch sensing device 120 to a first touch mode. If the projection display device 110 is not present, the touch sensing device 120 goes back to step S210 so step S210 may be performed again.

Next, in step S240, the processor circuit 121 performs a calculation of an image algorithm to obtain a coordinate point. In step S250, the projection display device 110 determines whether the status of the laser source 124 is changed. If the status of the laser source 124 is not changed, the processor circuit 121 goes back to step S240, and calculates the coordinate position according to a mapping relation. If the status of the laser source 124 is changed, the touch sensing device 120 goes back to step S210 so steps S210, S220 and S230 may be performed again to switch the touch mode of the touch sensing device 120 according to the statuses of the laser source 124 before and after the change in step S230. Then, the touch sensing device 120 performs the touch sensing operation according to the switched touch mode.

In addition, sufficient teaching, suggestion, and implementation illustration regarding the operating method of the touch sensing device in the embodiments of the invention may be obtained from the above embodiments depicted in FIG. 1 to FIG. 3, and thus related description thereof is not repeated hereinafter.

In summary, the embodiments of the invention have at least one the following advantages and effects. In the embodiments of the invention, by establishing the communication mechanism between the projection display device and the touch sensing device, the information regarding the image frame changed by the projection display device may be obtained by the touch sensing device. The user may directly use the touch sensing function without using the calibration procedure to perform the secondary calibration, such that favorable user experience may be provided. In addition, when the projection display device is set to stop providing the operating power to the laser source, the touch sensing device may obtain the information regarding the status of the light source being changed via the first signal transmission interface and the second signal transmission interface. Accordingly, the touch mode may be switched so user experience may be improved since a preferable touch effect may be obtained in the different touch modes.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
a projection display device being configured to project an image frame on a projection plane, and the projection display device comprising a first signal transmission interface; and
a touch sensing device being electrically connected to the projection display device and configured to sense a touch operation on the projection plane, and the touch sensing device comprising a second transmission interface,
wherein the projection display device and the touch sensing device perform a signal transfer operation via the first transmission interface and the second transmission interface, and the signal transfer operation comprises transferring an image parameter of the image frame.

2. The projection system of claim 1, wherein the touch sensing device is configured to define a sensing range according to the image parameter of the image frame received by the projection display device so the touch sensing device is able to sense the touch operation on the projection plane within the sensing range.

3. The projection system of claim 1, wherein the image parameter comprises at least one of a size dimension and a resolution of the image frame.

4. The projection system of claim 1, further comprising:
a host system, electrically connected to the projection display device and the touch sensing device and configured to provide the image frame to the projection display device, wherein the touch sensing device transfers a sensing result to the host system, and the host system controls the projection display device to project an image corresponding to the touch operation on the projection plane.

5. The projection system of claim 4, wherein the host system is configured to set the image parameter of the image frame, and the projection display device is adapted to project the image frame on the projection plane according to the image parameter.

6. The projection system of claim 1, wherein the projection display device transfers a mode-switching signal to the touch sensing device via the first transmission interface, and the touch sensing device receives the mode-switching signal via the second signal transmission interface to switch a touch mode, wherein the touch mode at least comprises a first touch mode and a second touch mode.

7. The projection system of claim 6, further comprising: a laser source, configured to provide a laser curtain adjacent to a lateral side of the projection plane receiving the image frame, wherein when a touch object performs the touch operation on the lateral side of the projection plane, the touch object reflects a first laser projected by the laser source, and the touch sensing device determines a touch position of the touch operation on the projection plane according to the reflected first laser.

8. The projection system of claim 7, wherein the projection display device is configured to provide an operating power to the laser source, and the projection display device transfers the mode-switching signal to the touch sensing device and the touch sensing device is switched from the first touch mode to the second touch mode according to the mode-switching signal when the projection display device stops providing the operating power to the laser source.

9. The projection system of claim 7, wherein the first touch mode comprises determining the touch position of the touch operation on the projection plane by the touch sensing device according to the first laser.

10. The projection system of claim 8, further comprising: a laser pen, configured to output a second laser for performing the touch operation on the projection plane, wherein the touch sensing device determines the touch position of the touch operation on the projection plane according to the second laser.

11. The projection system of claim 10, wherein the second touch mode comprises determining the touch position of the touch operation on the projection plane by the touch sensing device according to the second laser.

12. A touch sensing device adapted to a projection system, the touch sensing device comprising:
a signal transmission interface, configured to electrical connect to a projection display device, wherein the projection display device projects an image frame on a projection plane, and the touch sensing device is configured to sense a touch operation on the projection plane, wherein the projection display device and the touch sensing device perform a signal transfer operation via the transmission interface, and the signal transfer operation comprises transferring an image parameter of the image frame; and
another signal transmission interface, configured to electrically connect to a host system, wherein the touch sensing device provides a sensing result corresponding to the touch operation to the host system.

13. The touch sensing device of claim 12, wherein the projection plane is a PCT film adapted to receive the image frame projected from the projection display device and receive the touch operation.
